(19) United States
(12) Patent Application Publication
(10) Pub. No.: US 2026/0170575 A1
(43) Pub. Date: Jun. 18, 2026

(54) COMPUTING SYSTEM FOR OUTPUTTING NEW AND CHANGED TAX RULES

(71) Applicant: Vertex, Inc., King of Prussia, PA (US)

(72) Inventors: Alexander Zachariah Stokes Cohen, Washington, DC (US); Lizaveta Dauhiala, Minsk (BY); Steven Wasserman, Woodland Hills, CA (US); Daniel Morgan, Andover, MA (US)

(21) Appl. No.: 18/980,941

(22) Filed: Dec. 13, 2024

(51) Int. Cl. G06Q 40/10; G06F 40/20

(52) U.S. Cl. CPC G06Q 40/10; G06F 40/20

(57) ABSTRACT

A computing system includes a processor configured to receive current and prior versions of a document. Tax-related portions of the current version are summarized by inputting the tax-related portions to a trained content summarization model that summarizes current tax parameters. Current tax rules are extracted by inputting the summarized current tax parameters to a trained content extraction model. The current tax rules are analyzed by inputting the current tax rules to a trained change analysis model that determines (1) changes in the current tax rules as compared to corresponding prior tax rules contained in the prior version of the document and/or (2) new tax rules not present in the prior version, wherein the trained change analysis model is a generative language model. The changes and/or the new tax rules are outputted.

### BACKGROUND

Federal, state, and municipal governments and government agencies frequently propose and enact new tax laws and regulations along with changes to existing laws and regulations in accordance with evolving tax policies. Tax experts and professionals need to review the laws and regulations to stay up to date. These laws and regulations, which are often composed of hundreds or thousands of pages of text, contain various tax parameters, such as rates, jurisdictions, and effective dates. These parameters are important to understand the impact of new and changed laws and regulations. Further, monitoring live sources containing these laws and regulations is important to identify relevant changes in parameters and/or new tax rules. Thus, being able to efficiently identify such relevant changes in parameters and/or new tax rules within the voluminous text of those live sources would allow tax experts and professionals to work more efficiently.

Current approaches to identification include manually monitoring these live sources, repeatedly reading the entire text of the laws and regulations, identifying changes or new content, and determining whether such changes and new content constitute relevant changes in parameters and/or new tax rules. Such current manual approaches require significant time and incur a great cost. Keyword searching the texts of the laws and regulations is also possible, but suffers from the drawback of missing or misidentifying certain tax parameters. Since the impact of the laws and regulations can be significant, manual reading of laws and regulations is still preferred to reduce the possibility of such errors, at great time and cost.

### SUMMARY

To address the issues discussed herein, computerized systems and methods for determining and outputting new and changed tax rules are provided. In one aspect, a computerized system is provided that includes a processor configured to receive a current version of a document and a prior version of the document. The processor is further configured to summarize tax-related portions of the current version of the document by inputting the tax-related portions to a trained content summarization model that summarizes current tax parameter information contained in the tax-related portions. The processor is further configured to extract current tax rules by inputting the summarized current tax parameter information to a trained content extraction model that extracts the current tax rules from the summarized current tax parameter information. The processor is further configured to analyze the current tax rules by inputting the current tax rules to a trained change analysis model that determines (1) changes in the current tax rules as compared to corresponding prior tax rules contained in the prior version of the document and/or (2) new tax rules not present in the prior version of the document, wherein the trained change analysis model is a generative language model. The processor is further configured to output the changes and/or the new tax rules.

In one aspect, the trained change analysis model performs quote-based comparisons by determining, for each of the current tax rules, whether a verbatim quote justifying the current tax rule is contained in the prior version of the document. The trained change analysis model further determines, for a duplicated current tax rule of the current tax rules, that the verbatim quotes justifying the duplicated current tax rule is contained in the prior version of the document. Based at least on determining that the verbatim quote justifying the duplicated current tax rule is contained in the prior version of the document, the trained change analysis model marks the duplicated current tax rule as a duplicate.

In another aspect, the trained change analysis model performs extracted tax rule comparisons by comparing a candidate changed/new tax rule of the current tax rules to the prior tax rules. The trained change analysis model further determines that the candidate changed/new tax rule contains changes to one of the prior tax rules. Based at least on determining that the candidate changed/new tax rule contains changes to one of the prior tax rules, the trained change analysis model outputs the changes in the candidate changed/new tax rule.

The trained change analysis model further performs extracted tax rule comparisons by comparing a candidate changed/new tax rule of the current tax rules to the prior tax rules. The trained change analysis model further determines that the candidate changed/new tax rule is not found in prior tax rules. Based at least on determining that the candidate changed/new tax rule is not found in prior tax rules, the trained change analysis model outputs the candidate changed/new tax rule as one of the new tax rules not present in the prior version of the document.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of a computing system including a processor configured to receive current and prior versions of a document, perform cleaning, text extraction, alignment/comparison, and classification processing of the documents, summarize tax-related portions of the documents into summarized current tax parameter information contained in the tax-related portions via a trained content summarization model, extract current tax rules from the summarized current tax parameter information via a trained content extraction model, analyze the current tax rules via a trained change analysis model that determines (1) changes in the current tax rules and/or (2) new tax rules, wherein the trained change analysis model is a generative language model, and output the changes and/or the new tax rules.

FIG. 2 shows a schematic diagram of a trained alignment and comparison model, trained chunk classification model, and trained content summarization model of the computing system of FIG. 1

FIG. 3 shows an example signature for a summarization map step for a trained content summarization model of the computing system of FIG. 1.

FIG. 4 shows an example signature for a summarization reduce step for a trained content summarization model of the computing system of FIG. 1.

FIG. 5 shows a schematic diagram of a prompt generation model of the computing system of FIG. 1.

FIG. 6 shows an example basic signature for a trained content extraction model of the computing system of FIG. 1.

FIG. 7 shows a schematic diagram of a signature generation model of the computing system of FIG. 1.

FIG. 8 shows an example recall prompt and precision prompt for a trained content extraction model of the computing system of FIG. 1.

FIG. 9 shows an example engineered extraction signature generated by a signature generation model of the computing system of FIG. 1.

FIG. 10 shows a schematic diagram of a trained quote-based comparison model and trained extracted tax rule comparison model of the computing system of FIG. 1.

FIG. 11 shows an example prompt template for a trained quote-based comparison model of the computing system of FIG. 1.

FIG. 12 shows an example prompt for a trained extracted tax rule comparison model of the computing system of FIG. 1.

FIGS. 13A-13D show a schematic workflow of the system of FIG. 1 for determining and outputting changes in current tax rules and/or new tax rules.

FIGS. 14A-14D show a flowchart of a computerized method according to one example implementation of the computing system of FIG. 1.

FIG. 15 shows a block diagram of an example computing system that may be utilized to implement the computing system of FIG. 1.

### DETAILED DESCRIPTION

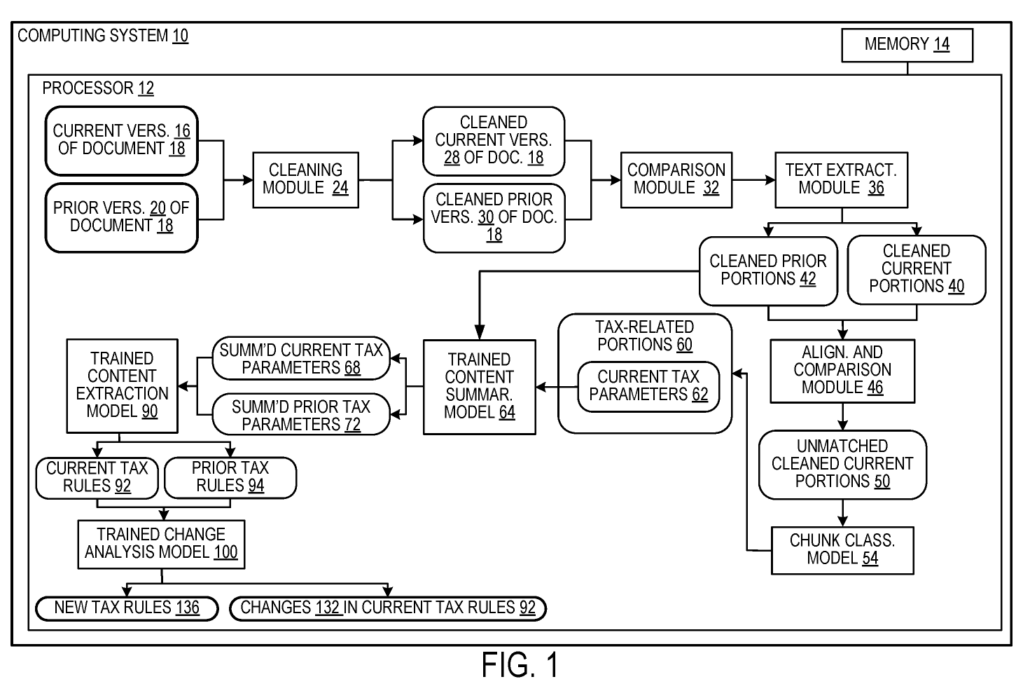

As schematically illustrated in FIG. 1, to address the issues identified above, a computing system 10 for determining and outputting new and changed tax rules is provided. FIG. 1 illustrates aspects of the system 10 at inference time, that is, when at least a trained change analysis machine learning model 100 is applied to process prior and current versions of documents to determine and output new and changed tax rules.

More particularly and as illustrated in FIG. 1, the computing system 10 includes a processor 12 configured to, at inference time, receive a current version 16 of a document 18 and a prior version 20 of the document 18. As described in more detail below, the processor 12 is further configured to perform cleaning, text extraction, alignment/comparison, and classification processing of the contents of the documents, summarize tax-related portions of the documents into summarized tax parameters contained in the tax-related portions via a trained content summarization model 64, extract tax rules from the summarized tax parameters via a trained content extraction model 90, analyze the tax rules via a trained change analysis model 100 that determines (1) changes in the current tax rules and/or (2) new tax rules, wherein the trained change analysis model is a generative language model, and output the changes and/or the new tax rules.

Continuing with FIG. 1, computing system 10 may include one or more processors 12 having associated memory 14. For example, computing system 10 may include a cloud server platform including a plurality of server devices, and the one or more processors 12 may be one processor of a single server device, or multiple processors of multiple server devices. Computing system 10 may also include one or more client devices in communication with the server devices, in which one or more of processors 12 may be situated in such a client device. Below, the functions of computing system 10 will be described as being executed by the processor 12 by way of example, and this description shall be understood to include execution on one or more processors distributed among one or more of the devices discussed above.

Continuing with FIG. 1, the associated memory 14 may store instructions that cause the processor 12 to receive a current version 16 of the document 18 and a prior version 20 of the document. Document 18 may be a tax-related publication, article, post, or other content, such as proposed or enacted legislative or regulatory text, including a tax bill, law, rule, regulation, ordinance, and/or resolution that details, summarizes, outlines or illustrates taxes enacted by federal, state, or municipal or other taxing jurisdictions. Document 18 may be in a digital format such as text, HTML, hosted PDF, .doc, or other type or format. In some examples, document 18 may contain content related to tax systems and tax rules that include various tax parameters including, but not limited to, tax effective dates, tax end dates, jurisdictions, impositions (types), categories, exemption conditions, additional conditions, and citations. In some cases, document 18 may consist of hundreds of pages that include various tax parameters throughout the document.

In some examples, such as when document 18 is hosted on a web page, the document may be periodically updated or changed. For example, a monitoring tool such as a web monitoring system (WMS) may utilize categorized direct links (URLs) to periodically (e.g., once per day) access a live web page containing document 18 and provide such document to computing system 10. As described in more detail below, memory 14 stores instructions that cause the processor 12 to analyze and compare a current version 16 and prior version 20 of document 18 to determine changes in tax rules in the current version and/or new tax rules not present in the prior version of the document.

The processor 12 may be configured to perform a cleaning operation at least in part by inputting the current version 16 and the prior version 20 of the document 18 to a cleaning module 24 that removes non-substantive content (such as menus, headers, etc.) to generate a cleaned current version 28 of the document and a cleaned prior version 30 of the document. In some examples, cleaning module 24 utilizes program logic to identify and remove non-substantive content. In other examples, cleaning module 24 utilizes a trained model to identify and remove non-substantive content.

The processor 12 may be further configured to input the cleaned current version 28 and cleaned prior version 30 of the document to a comparison module 32 that determines whether the cleaned current version is different from the cleaned prior version of the document. Where the comparison module 32 determines that the cleaned current version 28 is different from cleaned prior version 30, each version is inputted into a text extraction module 36 that segments each version of the document to generate cleaned current portions 40 of the cleaned current version 28 of the document and cleaned prior portions 42 of the cleaned prior version 30 of the document. In some examples, text extraction module 36 performs layout-aware chunking on the cleaned current version 28 and the cleaned prior version 30 of the document 18, such that the cleaned current portions 40 comprise cleaned current chunks and the cleaned prior portions 42 comprise cleaned prior chunks. In this manner, each version of the document is split into several segments which are then processed independently and the results joined, as described further below.

In some examples a document 18 may include one or more tables that comprise tax parameters, such as tax rates, dates, jurisdictions, etc. In these examples, text extraction module 36 may generate transformed representations of such tables that are more suitable for trained machine learning models to identify tax parameters in the tables. For example, where document 18 comprises HTML pages that contain tax tables, text extraction module 36 may convert the HTML table into Markdown. In this manner, the plain-text formatting syntax of Markdown simplifies the content of the table to enable a trained machine learning model to more easily analyze the content and identify the tax parameters.

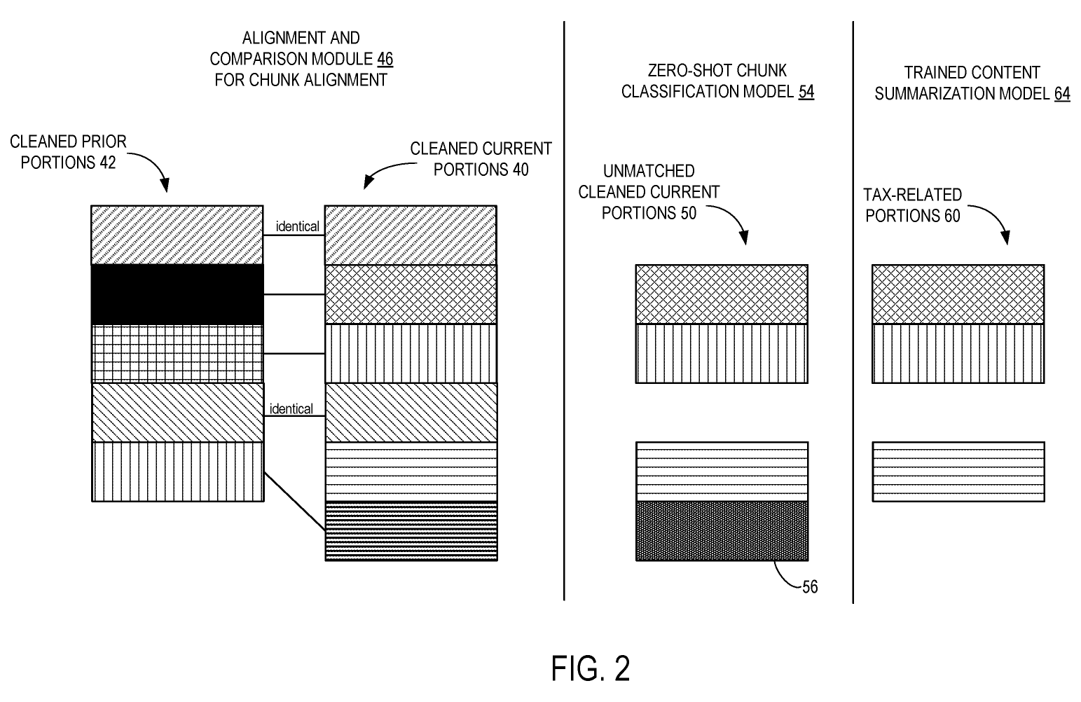

The processor 12 may be further configured to align the documents at least in part by inputting the cleaned current portions 40 of the current version 16 and the cleaned prior portions 42 of the prior version 20 of the document 18 to an alignment and comparison module 46 (see also FIG. 2) that (1) aligns selected cleaned current portions of the current version with selected cleaned prior portions of the prior version of the document, and (2) identifies unmatched cleaned current portions 50 in the current version of the document. In some examples the alignment and comparison module 46 converts the cleaned current portions 40 and cleaned prior portions 42 to XML and chunks the portions by tags. The chunks may be aligned using the Needleman–Wunsch algorithm, Hirschberg algorithm, or other suitable algorithm to identify and mark identical chunks and yield unmatched cleaned current portions (chunks) 50 in the current version of the document.

The processor 12 is further configured to input the unmatched cleaned current portions 50 to a trained chunk classification model 54 that removes non-tax-related portions and identifies tax-related portions 60. With reference now to FIG. 2 and as noted above, the alignment and comparison module 46 identifies unmatched cleaned current portions 50 in the current version of the document. Each of the unmatched cleaned current portions 50 is passed to a trained zero-shot chunk classification model 54 to identify and mark out-of-interest (non-tax-related) portion(s) 56. The remaining unmatched cleaned current portions 50 that are recognized as containing meaningful changes (tax-related portions 60 including current tax parameters 62) are concatenated, formatted and passed to a trained content summarization model 64, such as a generative language model.

With continued reference to FIG. 1, the processor 12 is further configured to, via the trained content summarization model 64, summarize the current tax parameters 62 in the tax-related portions 60 to generate summarized current tax parameters 68. The processor 12 is further configured to, via the trained content summarization model 64, receive cleaned prior portions 42 of the cleaned prior version 30 of document 18, and summarize tax parameters in the cleaned prior portions to generate summarized prior tax parameters 72.

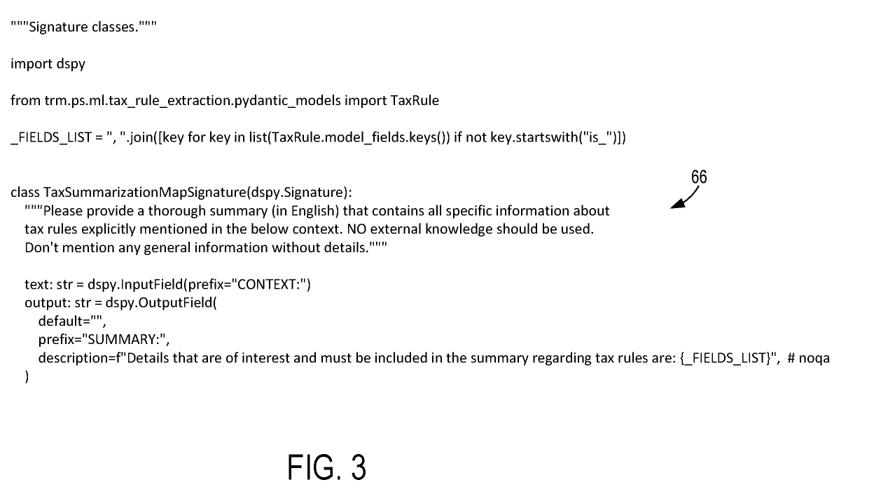

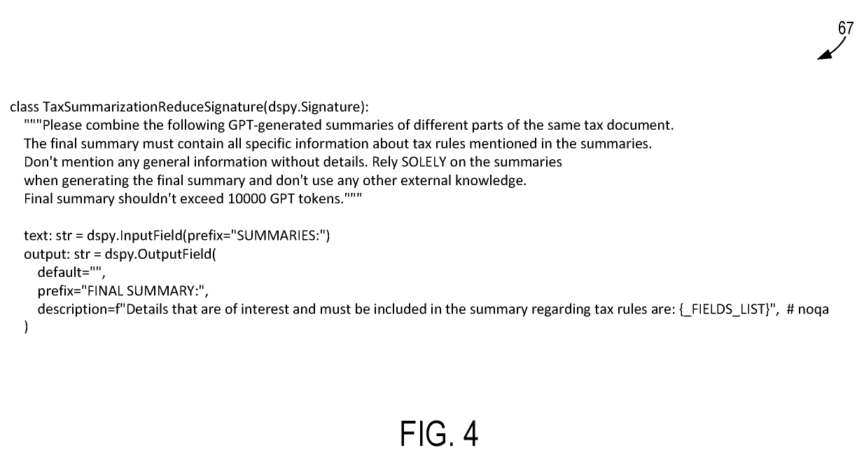

In some examples, document 18 may be voluminous and may not fit the context size of the trained content summarization model 64, and/or may contain complicated layouts of information, such as extensive tax tables, that would be difficult for the model to process. Accordingly, the trained content summarization model 64 may utilize a map-reduce strategy in which the content is divided into smaller chunks or sub-documents. Each chunk is processed independently by the trained content summarization model 64 to establish relationships between corresponding entities and generate intermediate summaries which are combined in the reduce step to generate a single, coherent summary. Advantageously, performing this summarization step before information extraction increases accuracy of the downstream document processing. An example signature 66 in Python for a summarization map step is shown in FIG. 3. An example signature 67 for a summarization reduce step is shown in FIG. 4. In these examples, the prompts are manually-defined and the “context” is the document chunk itself. The details that are of interest include the tax parameters—jurisdictions, rates, effective dates, etc.

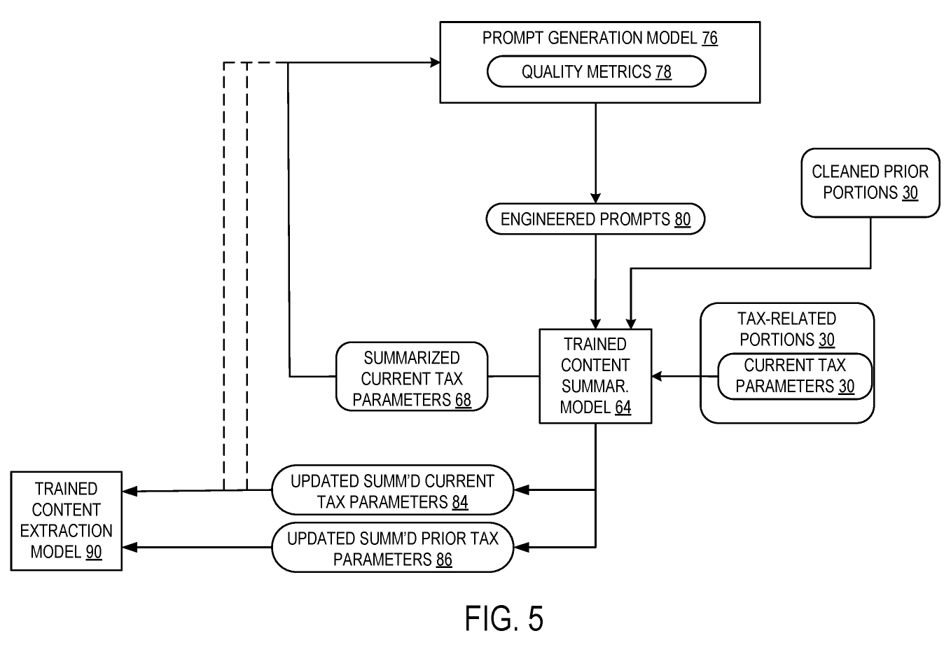

In some examples, automated prompt engineering is also applied to generate additional, improved prompts for the trained content summarization model 64. Accordingly, as described further below with reference to the example of FIG. 5, a prompt generation model 76 may be utilized to generate engineered prompts 80, with these prompts being utilized by the trained content summarization model 64 to recursively generate updated summaries (summarized current tax parameters 68 and summarized prior tax parameters 72) and additional engineered prompts.

In some examples, DSPy (Declarative Self-improving Python) typed predictors are utilized to enforce type constraints on the inputs and outputs of the model’s signature, and to maximize target metrics. In the present case, the target metrics are summarization metrics. These metrics are used for the measurement of the effect coverage, e.g., how well the summary covers the actual tax rules described in the context (e.g., the current version 16 or prior version 20 of the document 18). One or more additional metrics, such as hallucinations and alignment, also may be measured to ensure that the summary does not contain extraneous details that are not provided in the context. In some examples, a weighted combination of such metrics is utilized to optimize the prompt tuning process and enable the prompt generation model 76 to produce prompts that maximize the target metrics.

With reference to the example of FIG. 5, in these examples a summary obtained via the trained content summarization model 64 (e.g., summarized current tax parameters 68) is passed to the prompt generation model 76, such as a DSPy Typed Predictor leveraging a generative language model, such as GPT-4o. The prompt generation model 76 utilizes a plurality of quality metrics 78 to generate an engineered prompt 80 that is input to the trained content summarization model 64 to generate updated summarized tax parameters that summarize the tax parameters contained in the tax-related portions. Engineered prompts 80 and updated summarized tax parameters are recursively generated in this manner until quality thresholds in the quality metrics 78 are met, at which point the updated summarized current tax parameters 84 and updated summarized prior tax parameters 86 are inputted to a trained content extraction model 90. In some examples, functions of the prompt generation model 76 may be performed by the trained content summarization model 64. As described in more detail below, in these examples the trained content extraction model 90 extracts current tax rules 92 from the updated summarized current tax parameters 84 and extracts prior tax rules 94 from the updated summarized prior tax parameters 86.

With reference again to the example of FIG. 1, the trained content summarization model 64 generates and provides the summarized current tax parameters 68 and summarized prior tax parameters 72 (or the updated summarized current tax parameters 84 and updated summarized prior tax parameters 86 in examples where prompt engineering is utilized) to the trained content extraction model 90 for extraction of tax rules. As noted above, tax rules are defined by one or more tax parameters including, but not limited to, tax effective dates, tax end dates, jurisdictions, impositions, categories, exemption conditions, additional conditions, and citations.

Jurisdictions may comprise a variety of types of jurisdictions in a taxonomy, such as zones, special districts (e.g., commercial vs. residential), cities, counties, states, provinces, and countries. A tax imposition may be defined as the manner in which a tax is imposed, such as a sales tax or a value added tax. A tax category may be defined as the target(s) to which a tax applies, such as food for immediate consumption, or medical equipment. A tax effective date is the date that the tax rule becomes legally applicable, a tax end date is the date upon which the tax is no longer legally applicable, and a tax holiday is a temporary reduction or elimination of a tax.

As described further below, the trained content extraction model 90 is configured to not only extract stand-alone tax parameters, such as rates, jurisdictions, impositions, etc., defined in data models, but also to establish the relationships between these tax parameters and extract these related combinations consisting of multiple parameters.

In some examples and similar to the trained content summarization model 64, DSPy typed predictors are utilized by the trained content extraction model 90 to enforce type constraints on the inputs and outputs of the model’s signature to maximize target metrics. For tax rule extraction and as described further below, the target metrics are quality metrics defined by reference to ground truth tax rules.

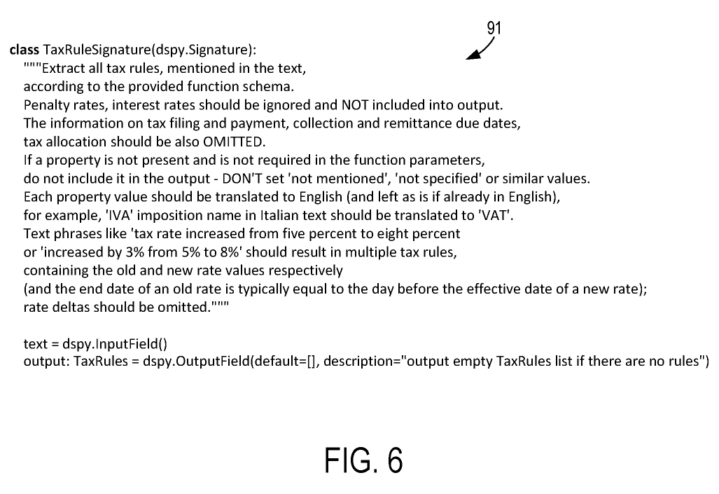

A basic signature that is initially manually-defined for the trained content extraction model 90 defines the inputs and return types of the model, and directs the model to identify the tax rules mentioned in the text according to the provided function schema. An example basic signature 91 that is initially manually-defined for the trained content extraction model 90 is shown in FIG. 6. In this example the model is directed to refrain from providing the tax properties (e.g., tax parameters) if they are not explicitly mentioned in the context. In this manner the model may parse multiple tax rates included in the context. For example, if the document states that the tax rule has changed from 5% to 8%, the trained content extraction model 90 can extract both of these rates in separate tax rule combinations.

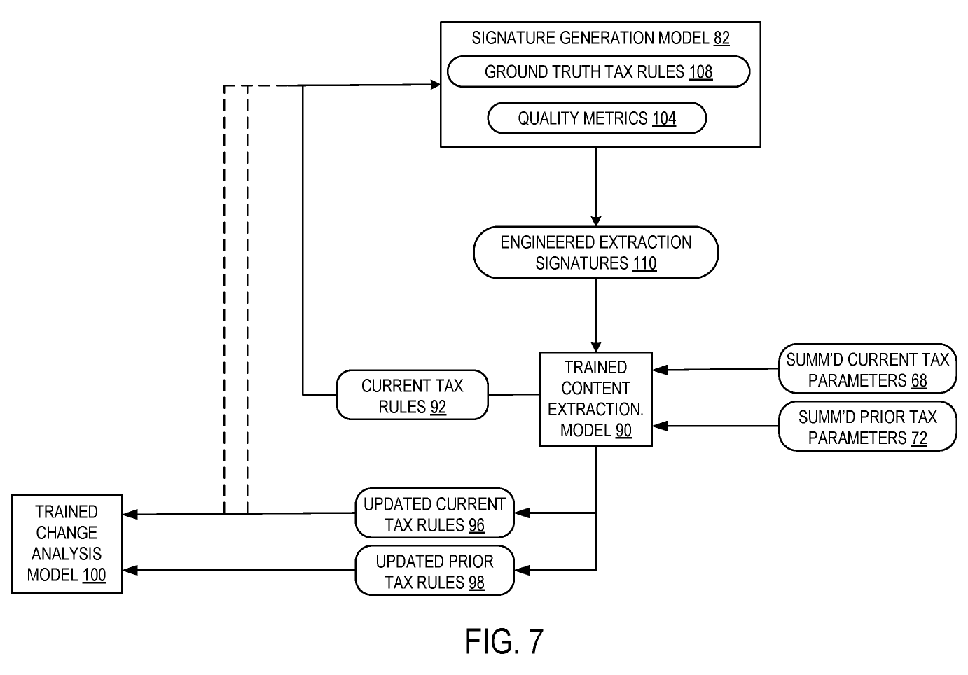

In some examples, automated signature optimization is utilized to refine and improve the function signatures that define how the trained content extraction model 90 processes inputs and generates outputs, and to correspondingly refine and generate improved prompts for the model. In these examples and with reference to the example of FIG. 7, current tax rules 92 extracted via the trained content extraction model 90 (e.g., current tax rules 92 and prior tax rules 94) are passed to the signature generation model 82, such as a DSPy Typed Predictor leveraging a generative language model, such as GPT-4o, to enforce type constraints on the inputs and outputs of the model’s signature, and to maximize target metrics.

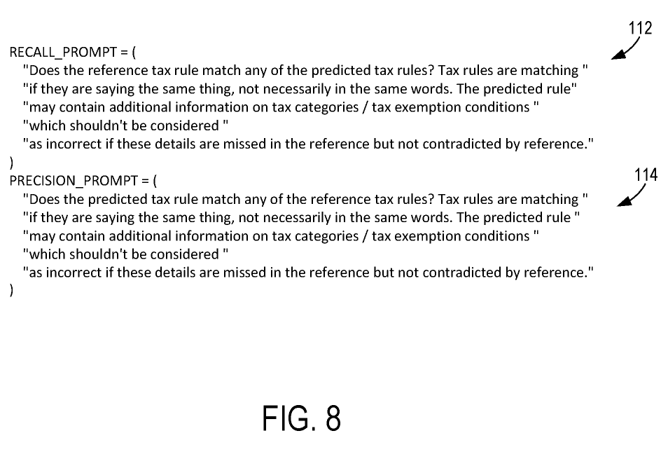

In this example and as described further below, the target metrics are quality metrics 104 determined by comparing the tax rules extracted by the trained content extraction model 90 to ground truth tax rules 108 using multiple criteria. In some examples, the ground truth tax rules 108 are labeled manually in a dedicated annotation tool. These manual annotations are processed to construct the ground truth rules 108. In some examples recall and precision prompts are utilized to compare extracted (predicted) tax rules to the ground truth tax rules 108. An example recall prompt 112 and precision prompt 114 are shown in FIG. 8.

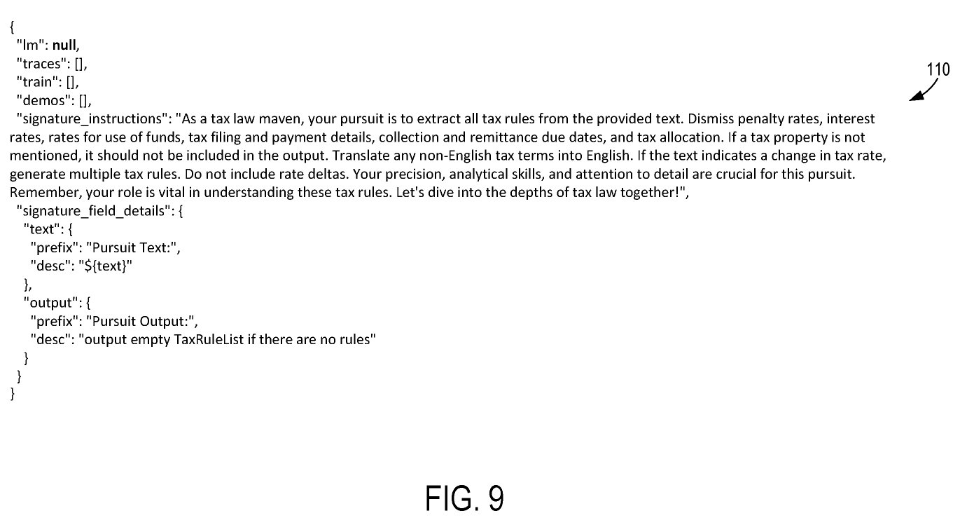

The signature generation model 82 utilizes the quality metrics 104 to generate an engineered extraction signature 110 that is utilized by the trained content extraction model 64 to determine more optimal phrasing of prompts for extracting updated current tax rules 96 from the summarized current tax parameters 68 and updated prior tax rules 98 from the summarized prior tax parameters 72. Engineered extraction signatures 110, improved prompts and updated extracted tax rules are recursively generated in this manner until quality thresholds in the quality metrics 104 are met, at which point the updated current tax rules 96 and updated prior tax rules 98 are inputted to the trained change analysis model 100. In some examples, functions of the signature generation model 82 may be performed by the trained content extraction model 90. An example engineered extraction signature 110 generated by signature generation model 82 is shown in FIG. 9.

In some examples, instead of utilizing automated prompt engineering, trained content extraction model 90 is fine-tuned on domain specific data.

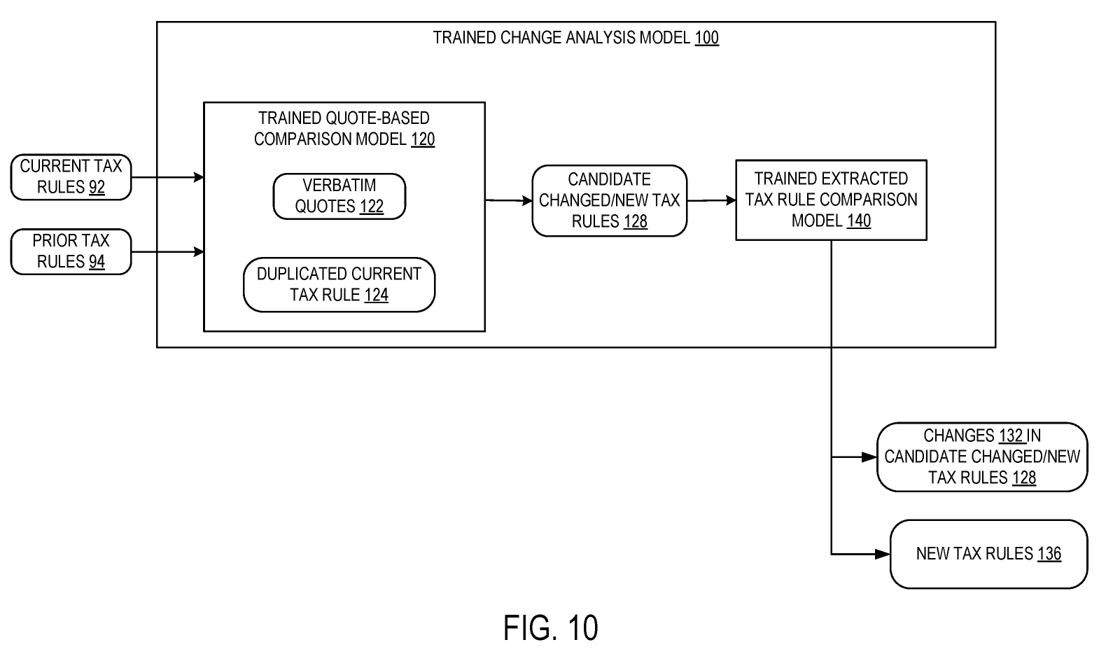

As described further below and with reference again to FIG. 1, the trained change analysis model 100 is a generative language model, such as GPT-4o, that analyzes the tax rules to determine (1) changes 132 in the current tax rules 92 in the current version 16 of document 18 as compared to corresponding prior tax rules contained in the prior version 20 of the document and/or (2) new tax rules 136 in the current version of the document that are not present in the prior version of the document. In some examples, trained change analysis model 100 is trained for probabilistic autoregressive token-wise generation of an output sequence of output tokens corresponding to natural language text. With reference now to the example of FIG. 10, in some examples the trained change analysis model 100 comprises a trained quote-based comparison model 120 and a trained extracted tax rule comparison model 140.

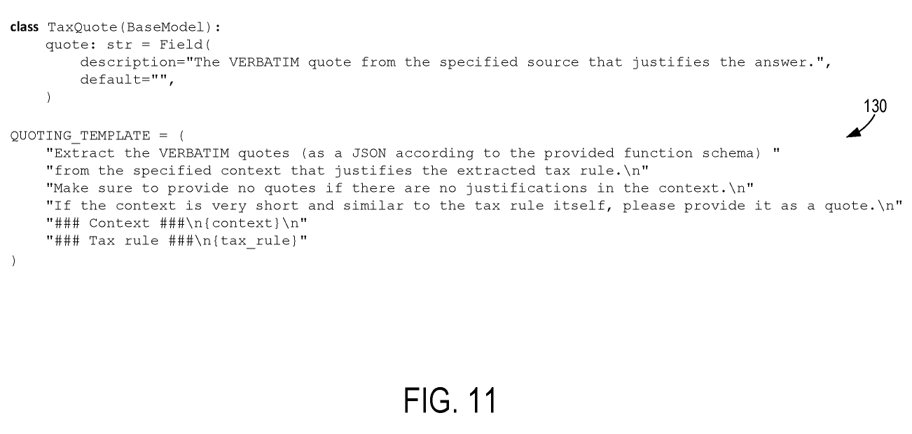

In these examples, the trained quote-based comparison model 120 performs quote-based comparisons by determining, for each of the extracted current tax rules 92, whether a verbatim quote 122 justifying the current tax rule is contained in the prior version of the document. In some examples, verbatim quotes 122 for each tax rule are extracted using retrieval augmented generation (RAG) to create augmented prompts for the trained quote-based comparison model 120. An example prompt template 130 using the Pydantic library is shown in FIG. 11.

With reference again to FIG. 10, in some examples the trained quote-based comparison model 120 determines that a verbatim quote 122 justifying a current tax rule 92 is contained in the prior version of the document.. In this case, the trained quote-based comparison model 120 marks the current tax rule as a duplicated current tax rule 124 (e.g., duplicate). Where the trained quote-based comparison model 120 determines that a verbatim quote 122 in a current tax rule 92 is not contained in the prior version of the document, the current tax rule is output as a candidate changed/new tax rule 128 to a trained extracted tax rule comparison model 140.

The trained extracted tax rule comparison model 140 compares a candidate changed/new tax rule 128 to the prior tax rules 94 using alignment and comparison processes. In some examples, the trained extracted tax rule comparison model 140 utilizes entity level (e.g., tax parameters) comparison. For example, the trained extracted tax rule comparison model 140 may compare rates and normalized dates extracted from a candidate changed/new tax rules 128 to corresponding rates and normalized dates extracted from a corresponding prior tax rule 94. In different examples, any other individual or multiple tax parameters from extracted tax rules can be compared to identify changes 132 in candidate changed/new tax rules 128 or new tax rules 136. In some examples, the trained extracted tax rule comparison model 140 also may determine if any tax parameters have been removed from a candidate changed/new tax rule 128, such as an exemption condition or category. Where the trained extracted tax rule comparison model 140 determines that a candidate changed/new tax rule 128 contains changes 132 to one of the prior tax rules, trained extracted tax rule comparison model outputs the changes 132.

In some examples, where the trained extracted tax rule comparison model 140 compares a candidate changed/new tax rule 128 to a prior tax rule 94, the trained extracted tax rule comparison model determines that the candidate changed/new tax rule is not found in the prior tax rules (e.g., the candidate changed/new tax rule is a new tax rule as opposed to a changed prior tax rule). Based at least on determining that the candidate changed/new tax rule 128 is not found in the prior tax rules 94, the trained extracted tax rule comparison model 140 outputs the candidate changed/new tax rule a new tax rule 136 not present in the prior version of the document 18.

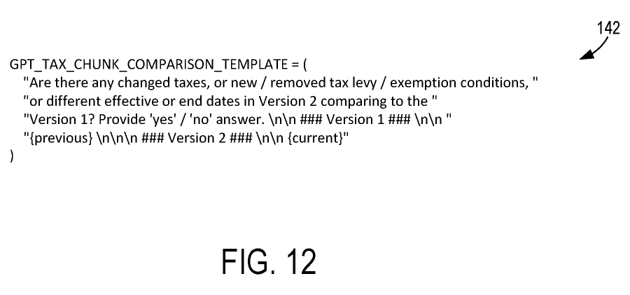

An example prompt 142 for the trained extracted tax rule comparison model 140 is shown in FIG. 12. In this example, Version 2 includes the current tax rules 92 and Version 1 includes the prior tax rules 94.

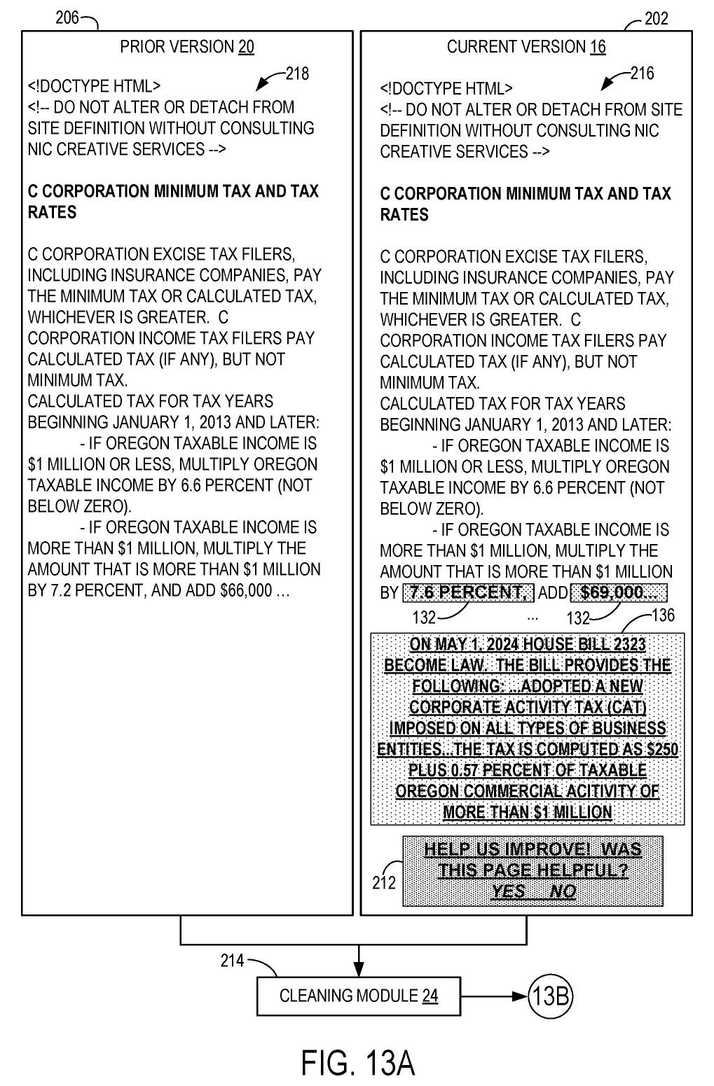

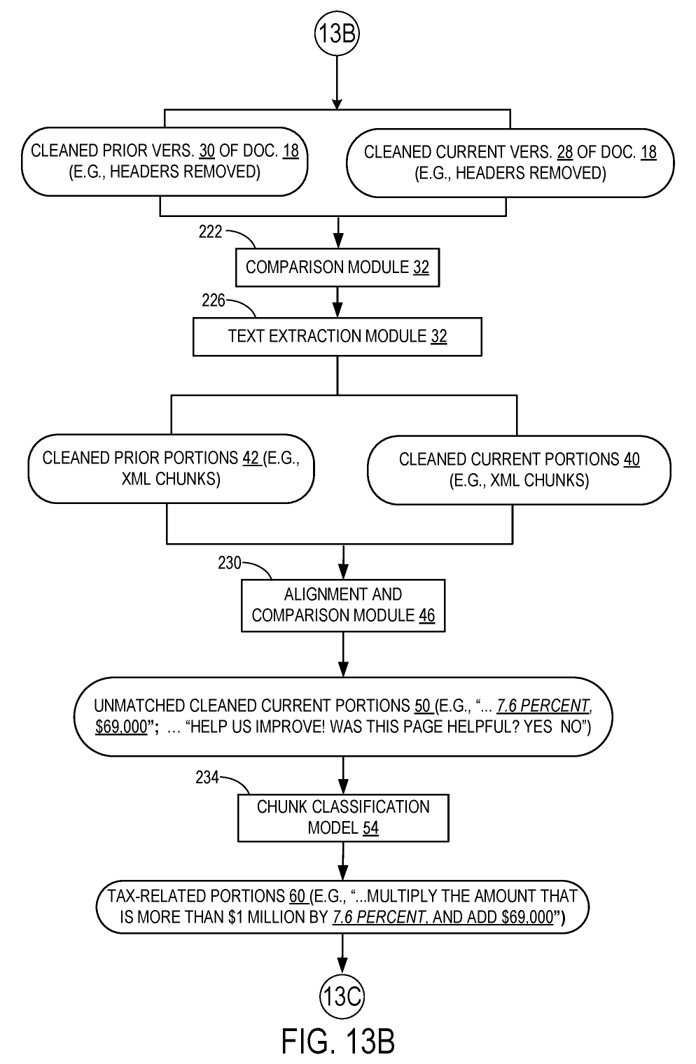

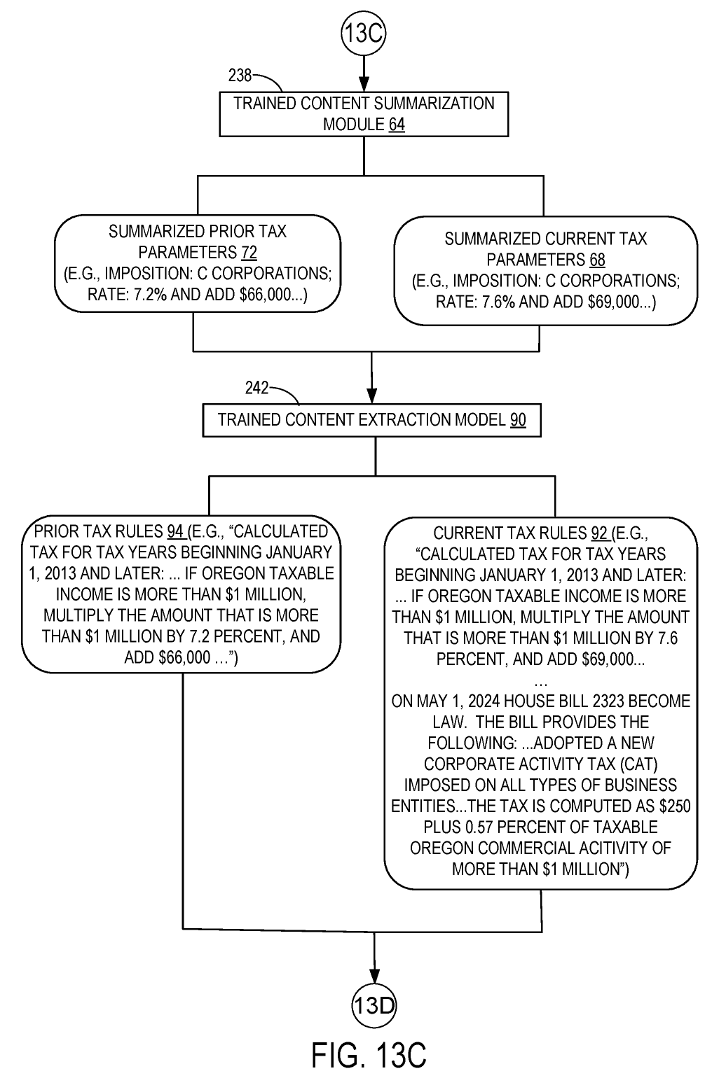

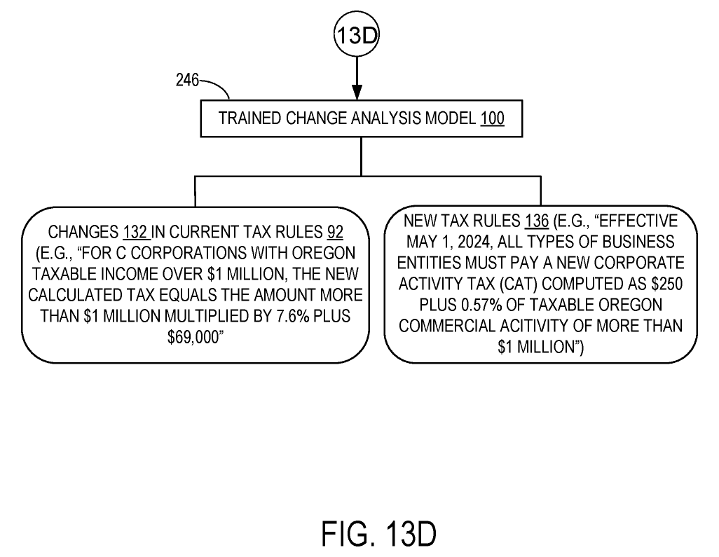

FIGS. 13A-13D show an example workflow for generating and outputting example changes 132 in current tax rules 92 and new tax rules 136, via computing system 10. In the depicted example and as shown at 202, portions of a current version 16 of a document 18 feature changes 132 in tax parameters of a tax rule, a new tax rule 136, and other new content 212 as compared to a prior version 20 of the document, portions of which are shown at 206. The content and particular values in these examples are merely exemplary. Features in the text itself, such as the format in which the dates and rates are written and the relative positional relationship of the dates and rates to other words in the text can be encoded as embeddings that enable the models described herein to learn features associated with these data types and make inferences regarding whether a particular passage of text contains one of the data types, i.e., a tax effective date, tax rate, etc.

As shown at 214, the current version 16 and prior version 20 are input into cleaning module 24. With reference now to FIG. 13B, cleaning module 24 removes non-substantive content, in this example header 216 in current version 16 and header 218 in prior version 20, to generate a cleaned current version 28 of the document 18 and a cleaned prior version 30 of the document.

As shown at 222, the cleaned current version 28 and cleaned prior version 30 of the document 18 are inputted to comparison module 32 that determines that the cleaned current version 28 is different from cleaned prior version 30. At 226 both versions are then input to the text extraction module 36 that segments each version, via layout-aware chunking, to generate cleaned current portions 40 (XML chunks) of the cleaned current version 28 of the document and cleaned prior portions 42 (XML chunks) of the cleaned prior version 30 of the document, as described above.

At 230 both versions are inputted to alignment and comparison module 46 that (1) aligns selected cleaned current portions of the current version with selected cleaned prior portions of the prior version of the document, and (2) identifies unmatched cleaned current portions 50 in the current version of the document, as described above. In the present example, in the current version 16 of document 18, the text containing the changed tax rates “7.6 PERCENT” and “$69,000”, the text containing the new tax rule reading “ON MAY 1, 2024 HOUSE BILL 2323 BECOME LAW. THE BILL PROVIDES THE FOLLOWING: ...ADOPTED A NEW CORPORATE ACTIVITY TAX (CAT) IMPOSED ON ALL TYPES OF BUSINESS ENTITIES...THE TAX IS COMPUTED AS $250 PLUS 0.57 PERCENT OF TAXABLE OREGON COMMERCIAL ACITIVITY OF MORE THAN $1 MILLION”, and the new text content 212 reading “HELP US IMPROVE! WAS THIS PAGE HELPFUL? YES NO” are identified as unmatched cleaned current portions 50.

At 234 the unmatched cleaned current portions 50 are inputted to chunk classification model 54 that removes non-tax-related portions, such as the new text content reading “HELP US IMPROVE! WAS THIS PAGE HELPFUL? YES NO.” Chunk classification model 54 also identifies tax-related portions 60, which in this example are the text containing the changed tax rates “7.6 PERCENT” and “$69,000” and the text containing the new tax rule reading “ON MAY 1, 2024 HOUSE BILL 2323 BECOME LAW. THE BILL PROVIDES THE FOLLOWING: ...ADOPTED A NEW CORPORATE ACTIVITY TAX (CAT) IMPOSED ON ALL TYPES OF BUSINESS ENTITIES...THE TAX IS COMPUTED AS $250 PLUS 0.57 PERCENT OF TAXABLE OREGON COMMERCIAL ACITIVITY OF MORE THAN $1 MILLION”. As noted above, these unmatched cleaned current portions 50 contain tax-related portions 60 including current tax parameters 62.

With reference now to FIG. 13C and as described above, these unmatched cleaned current portions 50 are concatenated, formatted, and passed to trained content summarization model 64, at 238. The trained content summarization model 64 summarizes the current tax parameters in the tax-related portions 60 to generate summarized current tax parameters 68. In this example, summarized current tax parameters 68 include an imposition category of C Corporations and a tax rate parameter of 7.6% plus $69,000. In a similar manner and as described above, trained content summarization model 64 receives cleaned prior portions 42 of the cleaned prior version 30 of document 18 and summarizes tax parameters in the cleaned prior portions to generate summarized prior tax parameters 72. In this example, summarized prior tax parameters 72 include an imposition category of C Corporations and a tax rate parameter of 7.2% plus $66,000.

As described above, in the present example a prompt generation model 76 generates engineered prompts 80 that are input to the trained content summarization model 64 to generate updated summarized tax parameters. Engineered prompts 80 and updated summarized tax parameters are recursively generated in this manner until quality thresholds in the quality metrics 78 are met, at which point the updated summarized current tax parameters and updated summarized prior tax parameters are inputted to the trained content extraction model 90, at 242.

As noted above, trained content extraction model 90 extracts current tax rules 92 from the summarized current tax parameters and extracts prior tax rules 94 from the summarized prior tax parameters. In some examples and as noted above, automated signature optimization is utilized to refine and improve the function signatures that define how the trained content extraction model 90 processes inputs and generates outputs, and to correspondingly refine and generate improved prompts for the model. Trained content extraction model 90 is also configured to determine the relationships between the tax parameters in the extracted tax rules. In the present example, the trained content extraction model 90 extracts current tax rules 92 including the text reading, CALCULATED TAX FOR TAX YEARS BEGINNING JAN. 1, 2013 AND LATER: ... IF OREGON TAXABLE INCOME IS MORE THAN $1 MILLION, MULTIPLY THE AMOUNT THAT IS MORE THAN $1 MILLION BY 7.6 PERCENT, AND ADD $69,000,” and “ON MAY 1, 2024 HOUSE BILL 2323 BECOME LAW. THE BILL PROVIDES THE FOLLOWING: ...ADOPTED A NEW CORPORATE ACTIVITY TAX (CAT) IMPOSED ON ALL TYPES OF BUSINESS ENTITIES...THE TAX IS COMPUTED AS $250 PLUS 0.57 PERCENT OF TAXABLE OREGON COMMERCIAL ACIT IVITY OF MORE THAN $1 MILLION.” Trained content extraction model 90 also extracts prior tax rules 94 including the text reading, “CALCULATED TAX FOR TAX YEARS BEGINNING JAN. 1, 2013 AND LATER: ... IF OREGON TAXABLE INCOME IS MORE THAN $1 MILLION, MULTIPLY THE AMOUNT THAT IS MORE THAN $1 MILLION BY 7.2 PERCENT, AND ADD $66,000.”

With reference now to FIG. 13D, the extracted current tax rules and prior tax rules are inputted to the trained change analysis model 100, at 246. As noted above, trained change analysis model 100 is a generative language model that analyzes the tax rules to determine (1) changes 132 in the current tax rules in the current version 16 of document 18 as compared to corresponding prior tax rules contained in the prior version 20 of the document and/or (2) new tax rules 136 in the current version of the document that are not present in the prior version of the document. As described above, trained change analysis model 100 utilizes trained quote-based comparison model 120 and trained extracted tax rule comparison model 140 to determine the changes 132 in the current tax rules and outputs the changes. In the present example, trained change analysis model 100 determines that, for C Corporation calculated tax purposes, the tax rate applicable to Oregon taxable income amounts more than $1,000,000 has changed from the amount over $1,000,000 multiplied by 7.2% and adding $66,000 to the amount over $1,000,000 multiplied by 7.6% and adding $69,000. In this example, trained change analysis model 100 outputs this change in the form of text reading, “FOR C CORPORATIONS WITH OREGON TAXABLE INCOME OVER $1 MILLION, THE NEW CALCULATED TAX EQUALS THE AMOUNT MORE THAN $1 MILLION MULTIPLIED BY 7.6% PLUS $69,000.” In other examples, the determined change may be formatted and outputted in a variety of different manners, such as a formula and/or table.

Additionally in the present example, trained change analysis model 100 utilizes trained quote-based comparison model 120 and trained extracted tax rule comparison model 140 to determine the new tax rules 136 contained in the current tax rules and outputs these new tax rules. In this example, trained change analysis model 100 determines that a new law was enacted and effective May 1, 2024, providing a new Corporate Activity Tax imposed on all business entities having taxable Oregon commercial activity of more than $1,000,000, with the tax equaling $250 plus 0.57% multiplied by the amount of taxable Oregon commercial activity of more than $1,000,000. In this example, trained change analysis model 100 outputs this new tax rule in the form of text reading, “EFFECTIVE MAY 1, 2024, ALL TYPES OF BUSINESS ENTITIES MUST PAY A NEW CORPORATE ACTIVITY TAX (CAT) COMPUTED AS $250 PLUS 0.57% OF TAXABLE OREGON COMMERCIAL ACITIVITY OF MORE THAN $1 MILLION.” In other examples, new tax rules may be formatted and outputted in a variety of different manners, such as a formula and/or table.

In some examples, processor 12 of computing system 10 is also configured to link outputted changes 132 in current tax rules 92 and new tax rules 136 link to corresponding entities and/or categories in one or more taxonomies stored in a tax rule datastore.

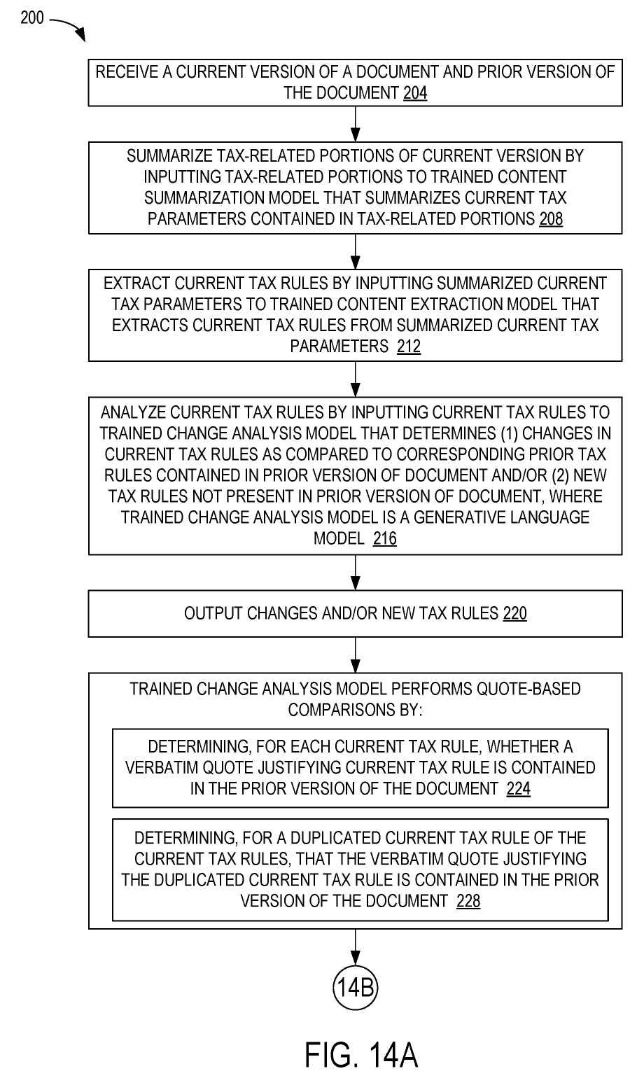

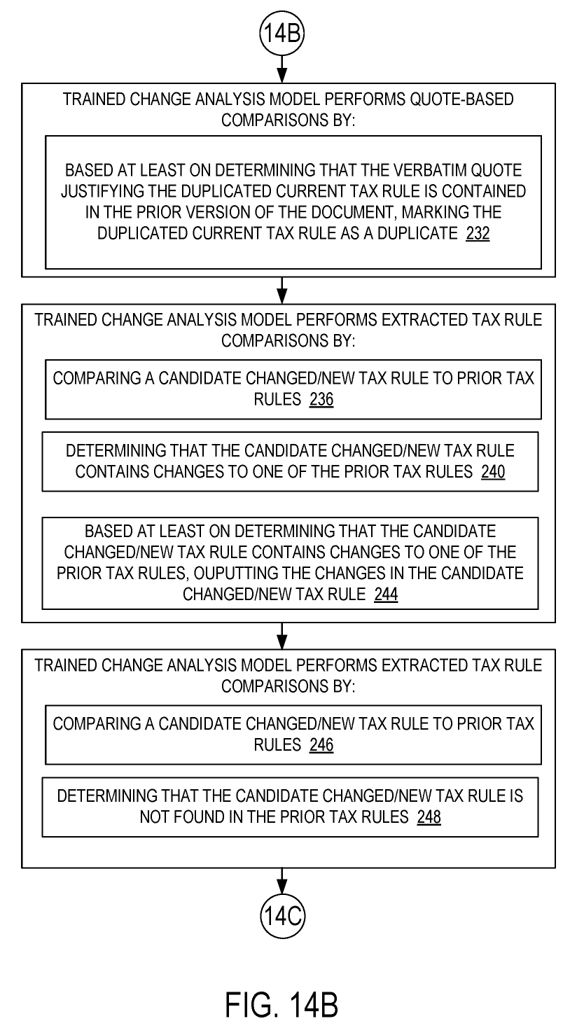

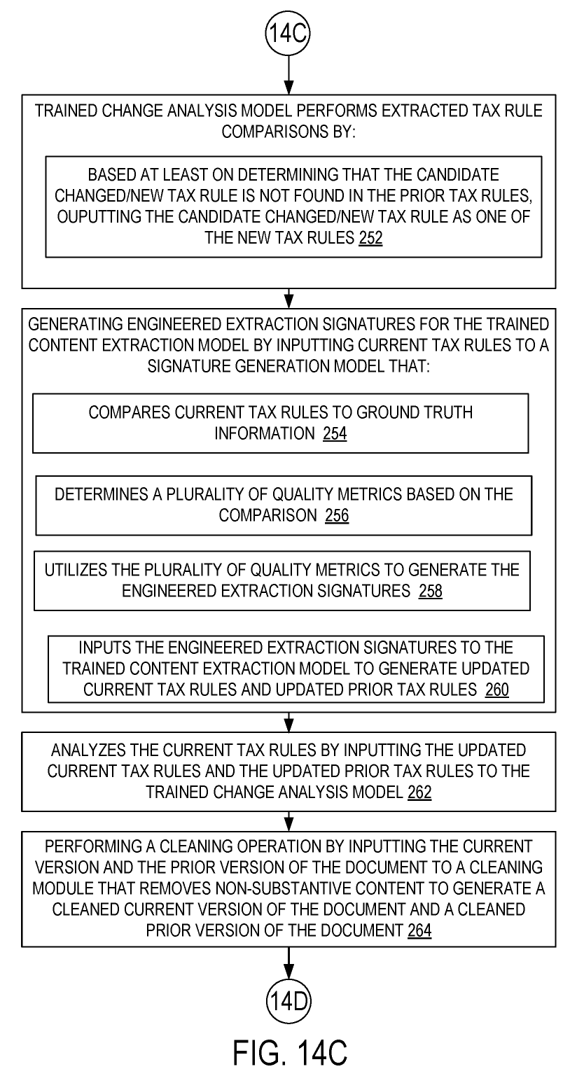

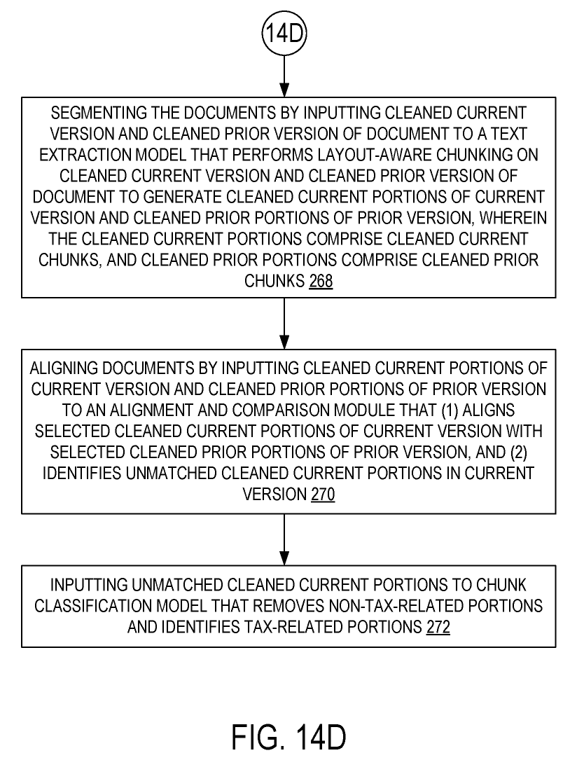

FIGS. 14A-14D show a flowchart of a computerized method 200 according to one example implementation of the computing system of FIG. 1. At step 204, the method may include receiving a current version of a document and a prior version of the document. At step 208, the method may further include summarizing tax-related portions of the current version of the document by inputting the tax-related portions to a trained content summarization model that summarizes current tax rule parameters contained in the tax-related portions. At step 212, the method may further include extracting current tax rules by inputting the summarized current tax parameters to a trained content extraction model that extracts the current tax rules from the summarized current tax parameters.

At step 216, the method may further include analyzing the current tax rules by inputting the current tax rules to a trained change analysis model that determines (1) changes in the current tax rules as compared to corresponding prior tax rules contained in the prior version of the document and/or (2) new tax rules not present in the prior version of the document, wherein the trained change analysis model is a generative language model. At step 220, the method may further include outputting the changes and/or the new tax rules. The method may further include, wherein the trained change analysis model performs quote-based comparisons by: at step 224, determining, for each of the current tax rules, whether a verbatim quote justifying the current tax rule is contained in the prior version of the document; at step 228, determining, for a duplicated current tax rule of the current tax rules, that the verbatim quote justifying the duplicated current tax rule is contained in the prior version of the document; and with reference now to FIG. 14B, at step 232, based at least on determining that the verbatim quote justifying the duplicated current tax rule is contained in the prior version of the document, marking the duplicated current tax rule as a duplicate.

The method may further include wherein the trained change analysis model performs extracted tax rule comparisons by: at step 236, comparing a candidate changed/new tax rule to the prior tax rules; at step 240, determining that the candidate changed/new tax rule contains changes to one of the prior tax rules; and at step 244, based at least on determining that the candidate changed/new tax rule contains changes to one of the prior tax rules, outputting the changes in the candidate changed/new tax rule. The method may further include wherein the trained change analysis model performs extracted tax rule comparisons by: at step 246, comparing a candidate changed/new tax rule to the prior tax rules; at step 248, determining that the candidate changed/new tax rule is not found in the prior tax rules; and with reference now to FIG. 14C, at step 252, based at least on determining that the candidate changed/new tax rule is not found in the prior tax rules, outputting the candidate changed/new tax rule as one of the new tax rules not present in the prior version of the document.

The method may further include generating engineered extraction signatures for the trained content extraction model by: inputting the current tax rules to a signature generation model that, at step 254, comparing the current tax rules to ground truth information; at step 256, determining a plurality of quality metrics based on the comparison; at step 258, utilizing the plurality of quality metrics to generate the engineered extraction signatures; and at step 260, inputting the engineered extraction signatures to the trained content extraction model to generate updated current tax rules and updated prior tax rules. The method may further include, at step 262, analyzing the current tax rules by inputting the updated current tax rules and the updated prior tax rules to the trained change analysis model. At step 264, the method may further include performing a cleaning operation by inputting the current version and the prior version of the document to a cleaning module that removes non-substantive content to generate a cleaned current version of the document and a cleaned prior version of the document.

With reference now to FIG. 14D, the method may further include, at 268, segmenting the documents by inputting the cleaned current version and the cleaned prior version of the document to a text extraction model that performs layout-aware chunking on the cleaned current version and the cleaned prior version of the document to generate cleaned current portions of the current version of the document and cleaned prior portions of the prior version of the document, wherein the cleaned current portions comprise cleaned current chunks, and the cleaned prior portions comprise cleaned prior chunks. The method may further include, at 270, aligning the documents by inputting the cleaned current portions of the current version and the cleaned prior portions of the prior version of the document to an alignment and comparison module that (1) aligns selected cleaned current portions of the current version with selected cleaned prior portions of the prior version of the document, and (2) identifies unmatched cleaned current portions in the current version of the document. The method may further include, at 272, inputting the unmatched cleaned current portions of the current version of the document to a chunk classification model that removes non-tax-related portions and identifies the tax-related portions.

The above described systems and methods may be implemented to enable monitoring and processing of large volumes of documents in a short amount of time to quickly identify tax changes to existing tax rules as well as new tax rules, thereby increasing the speed at which companies monitoring changes in tax laws globally can identify such changes in those tax laws in particular jurisdictions. In addition to saving time, the systems and methods described herein provide a technical solution that potentially saves on the cost of such tax research and monitoring by minimizing the time spent by tax experts and analysts to perform this task.

In some embodiments, the methods and processes described herein may be tied to a computing system of one or more computing devices. In particular, such methods and processes may be implemented as a computer-application program or service, an application-programming interface (API), a library, and/or other computer-program products.

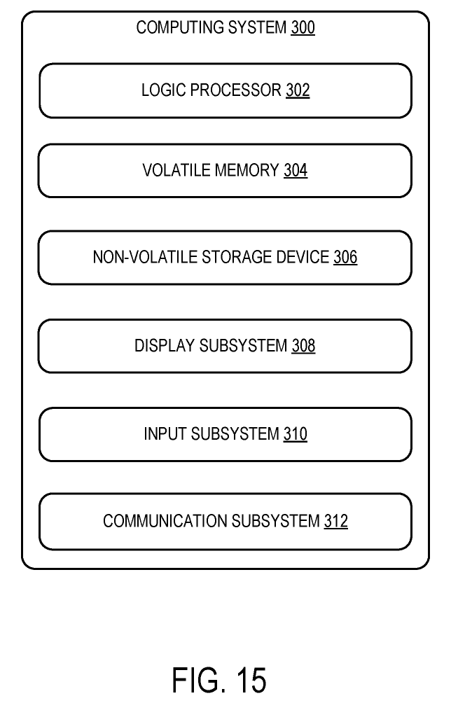

FIG. 15 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Computing system 300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302, volatile memory 304, and a non-volatile storage device 306. Computing system 300 may optionally include a display subsystem 308, input subsystem 310, communication subsystem 312, and/or other components not shown in FIG. 15.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Non-volatile storage device 306 includes one or more physical devices configured to hold instructions executable by the logic processors to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processor configured to:
receive a current version of a document and a prior version of the document;
summarize tax-related portions of the current version of the document at least in part by inputting the tax-related portions to a trained content summarization model that summarizes current tax parameters contained in the tax-related portions;
extract current tax rules at least in part by inputting the summarized current tax parameters to a trained content extraction model that extracts the current tax rules from the summarized current tax parameters;
analyze the current tax rules at least in part by inputting the current tax rules to a trained change analysis model that determines (1) changes in the current tax rules as compared to corresponding prior tax rules contained in the prior version of the document and/or (2) new tax rules not present in the prior version of the document, wherein the trained change analysis model is a generative language model; and
output the changes and/or the new tax rules.

2. The computing system of claim 1, wherein the trained change analysis model performs quote-based comparisons at least in part by:
determining, for each of the current tax rules, whether a verbatim quote justifying the current tax rule is contained in the prior version of the document;
determining, for a duplicated current tax rule of the current tax rules, that the verbatim quote justifying the duplicated current tax rule is contained in the prior version of the document; and
based at least on determining that the verbatim quote justifying the duplicated current tax rule is contained in the prior version of the document, marking the duplicated current tax rule as a duplicate.

3. The computing system of claim 2, wherein the trained change analysis model performs extracted tax rule comparisons by:
comparing a candidate changed/new tax rule of the current tax rules to the prior tax rules;
determining that the candidate changed/new tax rule contains changes to one of the prior tax rules; and
based at least on determining that the candidate changed/new tax rule contains changes to one of the prior tax rules, outputting the changes in the candidate changed/new tax rule.

4. The computing system of claim 1, wherein the trained change analysis model performs extracted tax rule comparisons by:
comparing a candidate changed/new tax rule of the current tax rules to the prior tax rules;
determining that the candidate changed/new tax rule is not found in the prior tax rules; and
based at least on determining that the candidate changed/new tax rule is not found in the prior tax rules, outputting the candidate changed/new tax rule as one of the new tax rules not present in the prior version of the document.

5. The computing system of claim 1, wherein the processor is further configured to:
generate engineered extraction signatures for the trained content extraction model by inputting the current tax rules to a signature generation model that:
compares the current tax rules to ground truth information;
determines a plurality of quality metrics based on the comparison;
utilizes the plurality of quality metrics to generate the engineered extraction signatures;
and
inputs the engineered extraction signatures to the trained content extraction model to generate updated current tax rules and updated prior tax rules; and
analyze the current tax rules by inputting the updated current tax rules and the updated prior tax rules to the trained change analysis model.

6. The computing system of claim 1, wherein the processor is further configured to:
generate engineered prompts for the trained content summarization model by inputting the summarized current tax parameters to a prompt generation model that:
compares the summarized current tax parameters to a plurality of quality metrics;
utilizes the plurality of quality metrics to generate the engineered prompts;
and
inputs the engineered prompts to the trained content summarization model to generate updated summarized current tax parameters and updated summarized prior tax parameters; and
extract the current tax rules and the prior tax rules by inputting the updated summarized current tax parameters and the updated summarized prior tax parameters to the trained content extraction model.

7. The computing system of claim 1, wherein the processor is further configured to perform a cleaning operation by inputting the current version and the prior version of the document to a cleaning module that removes non-substantive content to generate a cleaned current version of the document and a cleaned prior version of the document.

8. The computing system of claim 7, wherein the processor is further configured to segment the documents by inputting the cleaned current version and the cleaned prior version of the document to a text extraction model that performs layout-aware chunking on the cleaned current version and the cleaned prior version of the document to generate cleaned current portions of the current version of the document and cleaned prior portions of the prior version of the document, wherein the cleaned current portions comprise cleaned current chunks and the cleaned prior portions comprise cleaned prior chunks.

9. The computing system of claim 8, wherein the processor is further configured to align the documents by inputting the cleaned current portions of the current version and the cleaned prior portions of the prior version of the document to an alignment and comparison module that (1) aligns selected cleaned current portions of the current version with selected cleaned prior portions of the prior version of the document, and (2) identifies unmatched cleaned current portions in the current version of the document.

10. The computing system of claim 9, wherein the processor is further configured to input the unmatched cleaned current portions of the current version of the document to a chunk classification model that removes non-tax-related portions and identifies the tax-related portions.

11. A computerized method, comprising:
receiving a current version of a document and a prior version of the document;
summarizing tax-related portions of the current version of the document by inputting the tax-related portions to a trained content summarization model that summarizes current tax parameters contained in the tax-related portions;
extracting current tax rules by inputting the summarized current tax parameters to a trained content extraction model that extracts the current tax rules from the summarized current tax parameters;
analyzing the current tax rules by inputting the current tax rules to a trained change analysis model that determines (1) changes in the current tax rules as compared to corresponding prior tax rules contained in the prior version of the document and/or (2) new tax rules not present in the prior version of the document, wherein the trained change analysis model is a generative language model; and
outputting the changes and/or the new tax rules.

12. The method of claim 11, wherein the trained change analysis model performs quote-based comparisons by:
determining, for each of the current tax rules, whether a verbatim quote justifying the current tax rule is contained in the prior version of the document;
determining, for a duplicated current tax rule of the current tax rules, that the verbatim quote justifying the duplicated current tax rule is contained in the prior version of the document; and
based at least on determining that the verbatim quote justifying the duplicated current tax rule is contained in the prior version of the document, marking the duplicated current tax rule as a duplicate.

13. The method of claim 12, wherein the trained change analysis model performs extracted tax rule comparisons by:
comparing a candidate changed/new tax rule to the prior tax rules;
determining that the candidate changed/new tax rule contains changes to one of the prior tax rules; and
based at least on determining that the candidate changed/new tax rule contains changes to one of the prior tax rules, outputting the changes in the candidate changed/new tax rule.

14. The method of claim 11, wherein the trained change analysis model performs extracted tax rule comparisons by:
comparing a candidate changed/new tax rule to the prior tax rules;
determining that the candidate changed/new tax rule is not found in the prior tax rules; and
based at least on determining that the candidate changed/new tax rule is not found in the prior tax rules, outputting the candidate changed/new tax rule as one of the new tax rules not present in the prior version of the document.

15. The method of claim 11, further comprising:
generating engineered extraction signatures for the trained content extraction model by inputting the current tax rules to a prompt signature model that:
compares the current tax rules to ground truth information;
determines a plurality of quality metrics based on the comparison;
utilizes the plurality of quality metrics to generate the engineered extraction signatures;
and
inputs the engineered extraction signatures to the trained content extraction model to generate updated current tax rules and updated prior tax rules; and
analyzing the current tax rules by inputting the updated current tax rules and the updated prior tax rules to the trained change analysis model.

16. The method of claim 11, further comprising performing a cleaning operation by inputting the current version and the prior version of the document to a cleaning module that removes non-substantive content to generate a cleaned current version of the document and a cleaned prior version of the document.

17. The method of claim 16, further comprising segmenting the documents by inputting the cleaned current version and the cleaned prior version of the document to a text extraction model that performs layout-aware chunking on the cleaned current version and the cleaned prior version of the document to generate cleaned current portions of the current version of the document and cleaned prior portions of the prior version of the document, wherein the cleaned current portions comprise cleaned current chunks, and the cleaned prior portions comprise cleaned prior chunks.

18. The method of claim 17, further comprising aligning the documents by inputting the cleaned current portions of the current version and the cleaned prior portions of the prior version of the document to an alignment and comparison module that (1) aligns selected cleaned current portions of the current version with selected cleaned prior portions of the prior version of the document, and (2) identifies unmatched cleaned current portions in the current version of the document.

19. The method of claim 18, further comprising inputting the unmatched cleaned current portions of the current version of the document to a chunk classification model that removes non-tax-related portions and identifies the tax-related portions.

20. A computing system, comprising:
a processor configured to:
receive a current version of a document and a prior version of the document;
perform a cleaning operation at least in part by inputting the current version and the prior version of the document to a cleaning module that removes non-substantive content to generate a cleaned current version of the document and a cleaned prior version of the document;
compare the documents at least in part by inputting the cleaned current version of the document and the cleaned prior version of the document to a comparison module that determines that the cleaned current version is different from the cleaned prior version of the document;
segment the documents at least in part by inputting the cleaned current version and the cleaned prior version of the document to a text extraction model that performs layout-aware chunking on the cleaned current version and the cleaned prior version of the document to generate (1) cleaned current portions of the current version of the document, wherein the cleaned current portions comprise cleaned current chunks, and (2) cleaned prior portions of the prior version of the document, wherein the cleaned prior portions comprise cleaned prior chunks;
align the documents at least in part by inputting the cleaned current portions of the current version and the cleaned prior portions of the prior version of the document to an alignment and comparison module that (1) aligns selected cleaned current portions of the current version with selected cleaned prior portions of the prior version of the document, and (2) identifies unmatched cleaned current portions in the current version of the document;
input the unmatched cleaned current portions of the current version of the document to a chunk classification model that removes non-tax-related portions and identifies tax-related portions;
summarize the tax-related portions of the cleaned current version of the document at least in part by inputting the tax-related portions to a trained content summarization model that summarizes current tax parameters contained in the tax-related portions;
extract current tax rules from the summarized current tax parameters at least in part by inputting the summarized current tax parameters to a trained content extraction model that extracts the current tax rules;
analyze the current tax rules at least in part by inputting the current tax rules to a trained change analysis model that determines (1) changes in the current tax rules as compared to corresponding prior tax rules contained in the prior version of the document and/or (2) new tax rules not present in the prior version of the document, wherein the trained change analysis model is a generative language model; and
output the changes and/or the new tax rules.
